(19) United States
(12) Patent Application Publication
(10) Pub. No.: US 2021/0335141 A1
(43) Pub. Date: Oct. 28, 2021

(54) SYSTEMS AND METHODS FOR IMPROVING CASH MANAGEMENT SYSTEM OPERATION

(71) Applicant: Tidel Engineering, L.P., Carrollton, TX (US)

(72) Inventors: Darren Taylor, Frisco, TX (US); John T. Lee, Flower Mound, TX (US); Jerry Crawford, Flower Mound, TX (US); Steven Remis, Coppell, TX (US); Christopher Shelton, McKinney, TX (US)

(21) Appl. No.: 17/240,689

(22) Filed: Apr. 26, 2021

Related U.S. Application Data
(60) Provisional application No. 63/015,064, filed on Apr. 24, 2020.

(51) Int. Cl. G09B 5/02; G07D 11/26; G06F 21/32; G09B 5/08

(52) U.S. Cl. CPC G09B 5/02; G09B 5/08; G06F 21/32; G07D 11/26

(57) ABSTRACT

Implementations described and claimed herein provide systems and methods for improving cash management system operation. In one implementation, a method for improving cash management system operation includes detecting an intervention event in connection with user activity of a user involving a cash management system. The method determines whether the intervention event meets an intervention threshold. A customized intervention particular to the intervention event and a the user is generated when the intervention event meets the intervention threshold. The customized intervention is output for presentation to the user. The customized intervention improves the user activity involving the cash management system.

### CROSS-REFERENCE TO RELATED APPLICATION

The present application claims the benefit under 35 U.S.C. § 119 to U.S. Provisional Patent Application No. 63/015,064, entitled “Systems and Methods for Improving Cash Management System Operation” and filed on Apr. 24, 2020, which is incorporated by reference herein in its entirety.

### TECHNICAL FIELD

Aspects of the present disclosure relate to systems and method for improving an operation of a cash management system by one or more users and more particularly to a guided help and training artificial intelligence (AI) that detects user competencies through user interaction with the cash management system, adjusts a behavior of the cash management system to improve user competency, provides automatic intervention for the user, and/or reports user competency levels to a training administrator or vendor with recommendations for supplemental training.

### BACKGROUND

Sites, such as retailers, dining locations (e.g., a bar or a restaurant), department stores, casinos, grocers, financial institutions, money services, government offices, businesses, and/or the like, often utilize cash management systems to balance funds to an individual currency level and secure the funds for regular transfer to a financial institution for credit. There are often a plethora of different users associated with each site that all have varying levels of competency in operating cash management systems, which may include different devices, such as smart safes, recyclers, and/or the like. Typically, users are trained for a particular aspect of a cash management system in connection with on-site installation. For example, in connection with installation, a vendor may train a training administrator, who in turn trains other users associated with the site, such as executives, managers, cashiers, couriers, and/or the like. In some cases, the training administrator may provide training updates or reinforcements at varying intervals. With an initial training session and reinforcement with user over time, many users remain competent in operating the various aspects of a cash management system. However, with user turnover, additions of new users, infrequent use of certain functions, and differences in skills and learning capabilities among users, some users may struggle with accomplishing certain tasks associated with the operation of cash management systems. Identifying and responding to instances of such user struggle and other inefficiencies is challenging and often involves a expending significant resources, particularly for a site that involves a myriad of users having disparate levels of competency. It is with these observations in mind, among others, that various aspects of the present disclosure were conceived and developed.

### SUMMARY

Implementations described and claimed herein address the foregoing problems by providing systems and methods for improving cash management system operation. In one implementation, an intervention event in connection with user activity of a user involving a cash management system is detected, and it is determined whether the intervention event meets an intervention threshold. A customized intervention particular to the intervention event and a the user is generated when the intervention event meets the intervention threshold. The customized intervention is output for presentation to the user. The customized intervention improves the user activity involving the cash management system.

In another implementation, a command is received at a cash management system to initiate a training mode. The cash management system is transitioned from a transactional mode to the training mode. The training mode includes a training activity using training funds in connection with operation of the cash management system. A first set of funds having a value corresponding to the training funds is dispensed from the cash management system. The first set of funds is dispensed as an initial cash management operation. A set of one or more cash management operations is executed using the first set of funds with the cash management system. A second set of funds is received at the cash management system as a final cash management operation corresponding to a conclusion of the training activity. The initial cash management operation, the set of one or more cash management operations, and the final cash management operation are designated as training operations. The training operations are distinguished from transaction operations for the cash management system. The cash management system is transitioned from the training mode to the transactional mode.

In another implementation, a person within a threshold distance of a cash management system is detected. An identity of the person is determined using an authentication system. An authentication level for the person is determined based on the identity of the person. A login operation for the cash management system is bypassed based on the identity and the authentication level for the person. One or more settings of the cash management system is customized based on the identity and the authentication level for the person.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example guided help and training AI environment for improving cash management system operation.

FIG. 2 shows an example network environment that may implement various aspects of an intervention system.

FIG. 3 depicts various components of the guided help and training AI system including the intervention system.

FIG. 4 illustrates example operations for improving cash management system operation.

FIG. 5 is an example computing system that may implement various systems and methods discussed herein.

### DETAILED DESCRIPTION

Aspects of the present disclosure involve systems and methods for improving cash management operation. Generally, a training AI algorithm of an intervention system monitors user actions in connection with operation of a cash management system and detects when one or more users needs intervention, for example in the form of help or training, to accomplish a task. In one aspect, the training AI algorithm monitors actions taken by a user in real time and detects when an intervention event occurs. The intervention event may correspond to an erroneous action taken by the user, an inefficiency in an action taken by the user, a new action not yet taken by the user, and/or the like. Upon detecting the intervention event, the training AI algorithm generates a customized intervention in the form of a user intervention that is particular to the intervention event and/or the user, such as offering help to correct the actions that triggered the intervention event or to train a user on a new operation. In another aspect, the training AI algorithm processes historical data of user actions in connection with operation of the cash management system to detect any intervention events for a user or group of users to generate a customized intervention in the form of a user intervention that provides additional training or intervention analytics detailing recommendations for additional training. Such training may be provided through additional training by a training administrator, access to videos or tutorials, interactive assistance during operation of the cash management system, and/or the like.

The presently disclosed technology generally improves user competency in operating cash management systems, particularly for new users and users that have demonstrated some level of difficulty in performing or understanding certain tasks. The training AI algorithm intelligently monitors and logs user activities to detect any intervention events triggered by the user activities. The training AI algorithm generates a customized intervention to assist users through both first-time tasks and those tasks the user has difficulty mastering. The training AI algorithm tracks a level of training, expectations regarding tasks, and user experience with a particular cash management system device for a user or group of users, which the training AI algorithm may use as a competency baseline for identifying customized interventions. Thus, the presently disclosed technology optimizes user competency in operating cash management systems, while minimizing resources expended in connection with training and troubleshooting. Other advantages of the presently disclosed technology will be apparent from the present disclosure.

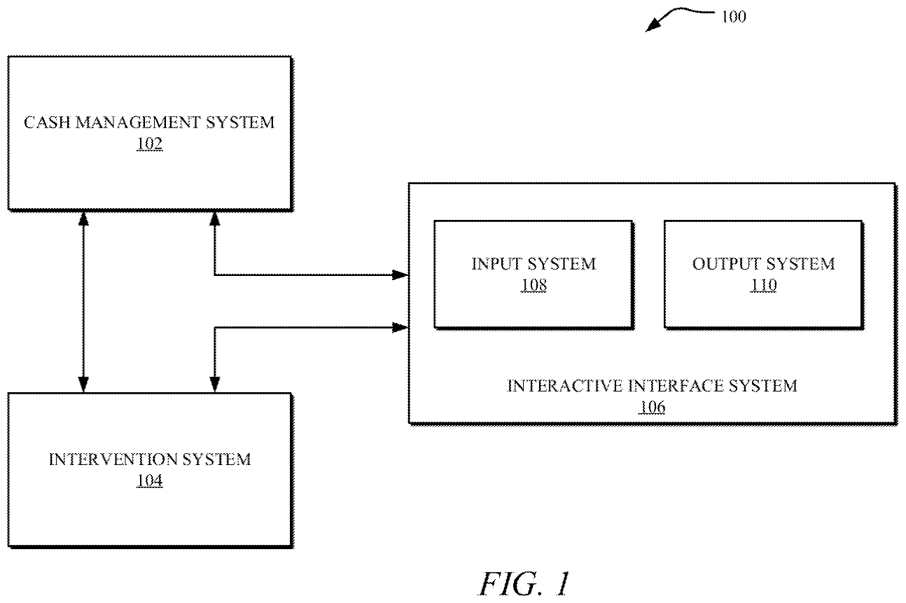

To begin a detailed description of an example guided help and training AI environment 100 for improving cash management system operation, reference is made to FIG. 1. The environment 100 is deployed at a site of an organization, which may be, without limitation, a financial institution, a money services business, a retailer, a casino, a restaurant, a bar, a government office, a medical business, a convenience store, a big-box retailer, a currency processing center, a military bases, or a similar entity that receives, dispenses, and otherwise manages cash during the course of normal operations. Generally, the organization manages and secures valuable objects, which may include cash, notes, currency and/or the like, using a cash management system 102, which may involve one or more cash management devices.

The operational complexity of such cash management devices may range significantly from simple cash boxes to automated registers and tills to intelligent storage vaults to smart safe deposit machines and accessories to complex note and coin recycling/depositing machines to automated bank branch equipment and automated teller machines, among other devices. Each of these types of devices has differing functionality and control mechanisms, such that the associated skills for competent operation varies from device to device.

User training for proper operation of the various devices of the cash management system 102 may be provided within the context of the device and the user activities associated with the device type and user type (e.g., training administrator, executive, manager, cashier, courier, etc.). Examples of user activities, include, without limitation, depositing funds, dispensing funds, making change, providing card-related services (e.g., via an Automated Teller Machine (ATM), self-check-out device, etc.), performing cash room activities, making tills, checking in tills, obtaining or paying for loans, receiving payments, crediting for change (e.g., via a coin kiosk), checking out customers, bank teller operations, rolling coins, shipping, storing, unpackaging, installing, connecting, installing, normal operations, collecting cash, depositing cash, replenishing cash, taking loans, authenticating a user, dropping packages into a drop vault, cashing checks, scanning cards, sensing objects (e.g., with bar codes, NFC, RFID, cameras, etc.) servicing, unjamming, clearing errors, reporting, optimizing, training, communicating, end-of-lifing, and other activities related to proper cash management for the organization.

Some devices of the cash management system 102 may support effective user training with simple manuals. For example, a lock box, with instructions to bolt down (installation), unlock (operation), and replace lock components (service), generally involves little user training to maintain user competency and often can be accomplished with a simple manual. On the other hand, more complex systems often have multiple types of training materials. For example, a smart safe may include a user manual to instruct on the operation of the smart safe, plus a service manual provided to authorized servicers of the equipment. The service manual may be only available to those who have participated in an authorized service training class and have passed a competency exam based on the service material. Such products may also have guided help menus available to the user. Another example is a cash recycler system, in which the various user types are trained over multiple days regarding proper operation of the various functions of the device. Service personnel may be trained via a separate process, and couriers are trained via documented standard operating procedures. In some of these devices, help menus, help videos, instructional videos, and other user assistance artifacts are available on the cash management system 102 device itself.

However, many organizations have a high turnover in users or are otherwise frequently adding new users. When turnover and hiring are high, the opportunity to train new users about the use of the cash management system 102 often falls on the establishment itself, rather than on the training administrator who delivered an initial training session. As such, an organization may suffer from incomplete, incorrect, and/or missing training for one or more users or user groups.

As such, the environment 100 includes an intervention system 104 configured to improve the level of training of users throughout the lifecycle of the cash management system 102 instead of emphasizing training only during the installation process, while reducing a cost of training delivery and monitoring user competency to identify retraining opportunities, address user errors, and improve user efficiencies.

In one implementation, a user interacts with the intervention system 104 using an interactive interface system 106. The interactive interface system 106 may be integrated with the cash management system 102, the intervention system 104, and/or a user device. For example, in one implementation, the interactive interface system 106 is integrated into the cash management system 102. The intervention system 104 may be integrated into the cash management system 102 or separate from and in communication with the cash management system 102.

For the intervention system 104 to monitor user activity in connection with operation of the cash management system 102, as well as to interact with the user, the interactive user interface 100 may include an input system 108 and an output system 110. The input system 108 may include generally any form of input device in communication (wired or wireless) with the cash management system 102 and the intervention system 104 and configured to capture intervention data in the form of visual, audio, and/or tactile input. For example, the input system 108 may include one or more sensors, user devices, and/or the like. The user device is generally any form of computing device, such as a computer, mobile device, smartphone, tablet, multimedia console, interface console, and/or the like. The sensors may include without limitation microphones, imagers (e.g., camera), touchscreen sensors (e.g., resistive, surface acoustic, capacity, infrared (IR), optical, pressure, etc.), and/or the like. It will be appreciated that the input system 108, the cash management system 102, and/or the intervention system 104 may employ various visual, audio, and tactile processing techniques to ingest input from the user and cash management system 102 captured by the input system 108.

Similarly, the output system 110 may include generally any form of output device in communication (wired or wireless) with the cash management system 102 and the intervention system 104 and configured to provide visual, audio, and/or tactile output. The output system 110 may include, without limitation, displays, projectors, speakers, light sources, haptic devices, user devices, and/or the like. For example, the input system 108 and the output system 110 may be include as a touch screen integrated into the cash management system 102 through which operations of the cash management system 102 may be controlled or accessed and interactions with and interventions from the intervention system 104 may be provided.

In one implementation, the intervention system 104 guides one or more users through various operations and actions associated with the cash management system 102 in an engaging and efficient manner using the interactive interface system 106, thereby providing an enhanced user experience, increased user competency, and overall improved outcome. The intervention system 104 communicates with the interactive interface system 106 to generate and present a customized intervention. In some examples, the customized intervention is provided in the form of user intervention with directed, targeted, instruction regarding operation of the cash management system 104 using graphical icons or symbols, such as pop-up balloons, presented via a display or touch screen of the output system 110. As another example, the interactive interface system 106 may be integrated into the cash management system 102, such that the customized intervention is provided as an in-app tutorial guiding the user action in real time on a step-by-step basis, while the user interacts with the cash management system 102 during usual user activities using an application associated with the cash management system 102. The interactive interface system 106 may present audio, video, and/or other outside training content using the output system 110 to replace or supplement such in-app interventions presented within the application of the cash management system 102. The outside training content may be accessed manually using a Help button or automatically upon the triggering of an intervention event by user activity.

In one implementation, the interactive interface system 106 may be used in connection with the cash management system 102 to facilitate user authorization. For example, the input system 108 may include a pin pad or touch screen for entering a user password or pin, biometrics sensors for authenticating a user based on user biometrics (e.g., fingerprint recognition, facial recognition, voice recognition, etc.), identification sensors, such as an identification chip reader (e.g., iButton), and/or the like.

The intervention system 104 monitors user activity in connection with the user attempting to login to the cash management system 104 or with the cash management system 104 otherwise attempting to authenticate the user. User activity and/or device activity may trigger an intervention event where a threshold amount (e.g., 2 or more) of authentication fails occur. In response to the intervention event being triggered within the context of user authentication, the intervention system 104 may trigger a user intervention in real-time to guide the user through the user authentication process. For example, a dialogue box may be presented with the output system 110 stating that it looks like the user is having trouble logging in and asking if the user forgot the user password/pin, needs assistance with the fingerprint reader, needs assistance with the iButton reader, and/or the like depending on the authentication components, setup, and operation of the cash management system 104.

In one implementation, the intervention system 104 monitors user activity in connection with the normal operation of the cash management system 102. User activity corresponding to a new action that the user has performed a number of times less than a threshold number of times (e.g., performed 0-3 times) may trigger an intervention event. In response to the intervention event being triggered within the context of a new user activity, the intervention system 104 may trigger a user intervention in real-time to guide the user through the new user activity. For example, a dialogue box may be presented with the output system 110 stating that it looks like the user is attempting a specific activity that is new to that user and asks the user if guidance or training is desired by the user. The user may select yes to proceed with the user intervention or no to continue without the user intervention. There may also be an option to prevent such dialogue boxes from being presented in the future.

Examples of new user activities may include, without limitation, cash management operation activities, auditing activities, maintenance activities, configuration activities, and other user activity involving the cash management system 102. The cash management operation activities may include: starting a shift, cash pickup (including how to do it on behalf of another user), buying change, ending a shift, manual drops (if applicable), adding cash, cashing out, emptying reject (if applicable), preparing deposit (if using static balance, if physically removing cash and preparing a commercial deposit, etc.), viewing and printing reports, forcing check-in of a register, dispensing to overflow on a coin recycler (when a hopper is full or near full at idle, when a hopper becomes full during a transaction at an end of shift, cash pickup, or adding cash, etc.), and/or other operations involving functions of the cash management system 102. Auditing activities may involve auditing notes, coins, manual drops (clearing) of a recycler. Maintenance activities may involve cleaning and care of the cash management system 102, the interactive interface system 106, and other components of the environment 100. For example, maintenance activities may be directed to a note recycler, coin recycler, fingerprint reader and monitor, iButton reader, and/or the like. Configuration activities may involve editing a recycler configuration or a configuration of other components of the cash management system 102 and/or the interactive interface system 106. For example, configuration activities may include, without limitation, adding users, deleting users, modifying users or user profiles, adding users to groups or designating user types, enrolling users (including security level), and/or the like.

In one implementation, the intervention system 104 monitors user activity in connection with an error of the cash management system 102. User activity and/or device activity corresponding to addressing an error may trigger an intervention event. In response to the intervention event being triggered within the context of an error of the cash management system 102, the intervention system 104 may trigger a user intervention in real-time to guide the user through troubleshooting or addressing an error associated with functionality of the cash management system 102. For example, the intervention system 104 may detect a jam, which triggers an intervention event. In response, the intervention system 104 provides a user intervention to demonstrate the process for clearing the jam and/or guides the user through the process using the interactive interface system 106.

In addition to automatically triggering an intervention event based on monitored or detected user activity and/or device activity, an intervention event may be manually triggered by a user. In one implementation, the intervention system 104 may provide persistent background help during operation of the cash management system 102 that may be accessed by the user or otherwise triggered at any time during use with the interactive interface system 106. For example, a help button may be presented in the application controlling the cash management system 102 or otherwise accessible to the user via the output system 110. The button may located on a screen of the output system 110 in an unobtrusive location such as top or bottom corner. When an intervention event is manually triggered using the help button for example, the intervention system 104 may provide a user intervention by presenting the user with a search bar to input a topic and have matching topics appear in the area below the search bar as matches are found. For example, a user types in the letters “L-o-g” and below that appears the topic “Logging in to the system.” In another example, a tree view of all available help categories may be provided for the user to browse and select the relevant help.

Additionally, the help button or other manual intervention event trigger may be used to allow the user to send a message to the training administrator (e.g., vendor, vendor partner) if the desired help is not found to request additional help. In some cases, the message may be transmitted to the training administrator to follow-up with the user or other personnel with additional training, answers, guidance, or other interventions. In other cases, the message may be received in real-time to trigger a user intervention, such as remote operation or responses by the training administrator to provide real-time guidance or other intervention to the user.

In one implementation, an intervention event may be triggered through interaction with various buttons on any given navigation page or screen of the application for controlling the cash management system 102. For example, an intervention event may be triggered by hovering over or executing another triggering interaction with a button or by navigating to a new screen, and in response, a user intervention in the form of a brief explanation of the button may be provided. For example, where a user pushed the Status Screen button and is looking at the screen, pressing the Help button will trigger a user intervention in the form of a concise explanation of all the diagrams and buttons on the screen. As another example, an icon (e.g., a circle with a question mark inside) may be associated with each button (e.g., located at the top right corner of the button). When the user pushes the icon, a balloon may appear containing a description of the button's functionality.

Additionally, the interactive interface system 100 may provide a link, a QR code, and/or other mechanisms for accessing other remote or integrated tutorials or user interventions. As described herein, such outside training content may be provided via a user device, by a training administrator, via the interactive interface system 106, and/or the like. The various intervention events, customized interventions, and user interventions may be configurable and customized to each site or user. Further, a user may be prevented with an option to control the customized interventions. For example, on-screen “nag” messages to remind appropriate users of situations for which additional help is needed may be presented, as well as “don't show this message again” options.

As discussed herein, in some implementations, in addition to providing a customized intervention in the form of a user intervention in real-time for intervention events corresponding to a user or group of users, the intervention system 104 provides intervention analytics based on historical intervention events corresponding to a user of group of users. The intervention analytics may be provided in the form of reporting, feedback, customized targeted training, and/or the like.

For example, the intervention system 104 may generate intervention analytics to provide reporting of user activity that triggered an intervention event and feedback to a training administrator and/or user oversight (e.g., managers at the site and corporate level) as to users' performance and use of the intervention system 104. The intervention analytics may be provided at: an individual user level; aggregated user level according to user type, site, geographical area, device type, site type, organization, and/or the like. The intervention analytics may include, without limitation, multiple login attempts by users and number of incidents per user, unexpected button pushes and number of incidents per user, manually evoking help and number of attempts per user, note or coin jam incidents and number of incidents per user, and/or the like.

The intervention analytics may be provided by the intervention system 104 using the output system 110 and/or a user device in various formats, such as on screen, printed, emailed or otherwise via a message, on-demand through organization data acquisition methods, communicated to organization dashboards for an organization, such as Cash-in-transit (CIT) partner dashboards, and/or the like. The intervention analytics may enable CIT partners to proactively contact an organization about which users are struggling with certain functions to arrange additional training either on-site or remote by a training administrator, through tutorial sessions (e.g., videos or interactive sessions), or otherwise. In these cases, reports containing intervention analytics available at CIT partner dashboards would only be accessible to certain end-user organization personnel.

Similarly, intervention data from the intervention system 104 may be aggregated to assess and modify available training for the various users. The intervention data is aggregated for a given system 102, for a population of systems at multiple sites for a given organization, and for the entire population of users of all of the cash management systems 102. Other data aggregation means, such as parsing the data by trainer, by type of system, by geographic location, and/or the like is also included to better understand the areas of training and training methodologies for improvement.

As described herein, training content may be provided in various forms in connection with a customized intervention. For example, real time or historical intervention events in connection with various user activities may trigger a customized intervention involving tutorials including training videos presented to the user or groups of users on the relevant topics. In some cases, one or more users may be enrolled in a training session to watch selected videos, with the intervention system 104 or training administrator tracking verifying that the user(s) completed the training corresponding to the customized intervention. It will be appreciated that the training content may be provided in various manners, using various materials, and across multiple languages. The training content may be provided as videos, audio, immersive technology, slide shows, remote, live, on-demand, etc. The training content may include the user manual, including relevant sections to the training.

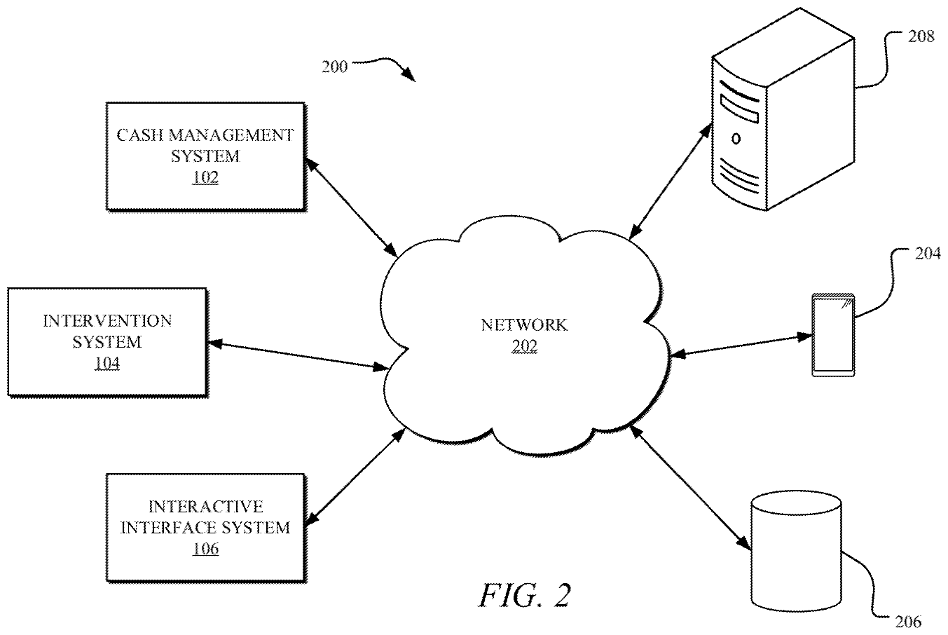

As described herein, the interactive interface system 106 may be used to access the intervention system 104 directly on the cash management system 102. Referring to FIGS. 1-2, the intervention system 104 may be accessed over a network 202 in a network environment 200 using the interactive interface system 106, which may be integrated with the cash management system 102 and/or a user device 204. More particularly, in one implementation, a user accesses and interacts with various aspects of the environment 200 using the interactive interface system 106 and/or the user device 204 to receive, access, operate, and/or control customized interventions and aspects of the intervention system 100 within the environment 200 and/or other information or services via the network 202.

The user device 202 is generally any form of computing device capable of interacting with the network 204, the intervention system 104 and/or the cash management system 102, such as a personal computer, terminal, workstation, desktop computer, portable computer, mobile device, smartphone, tablet, multimedia console, and/or the like. In some cases, the user device 204 is integrated into the interactive interface system 106. It will be appreciated that multiple user devices 204 may be deployed in the network environment 200 that communicate over the network 202 to access, operate, maintain, control, or otherwise interact with one or more connected cash management systems 102, with the intervention system 104, as well as other information, systems, or services.

The network 202 is used by one or more computing or data storage devices (e.g., one or more databases 206 or other computing units described herein) for implementing the various aspects of the intervention system 104 and other services, applications, or modules in the network environment 200. The user activities, intervention events, customized interventions (e.g., user interventions, intervention analytics, etc.) that are real time or historical, software, and other information utilized by the intervention system 104 or other aspects of the network environment 200 may be stored in and accessed from the one or more databases 206. In some implementations, some data is stored locally and may be transmitted to other systems or services of the network environment 200 over the network for use or storage in the one or more databases 206.

In one implementation, the network environment 200 includes at least one server 208 hosting a website or an application that the user may visit to access the intervention system 104 and/or other network components of the network environment 200. The server 208 may be a single server, a plurality of servers with each such server being a physical server or a virtual machine, or a collection of both physical servers and virtual machines. In another implementation, a cloud hosts one or more components of the network environment 200. The user devices 204, the server 208, and other resources connected to the network 202 may access one or more other servers to access to one or more websites, applications, web services interfaces, storage devices, computing devices, or the like that are used for training, troubleshooting, intervention analysis, tracking, and related services. The server 206 may also host a search engine that the intervention system 104 uses for accessing, searching for, and modifying user data, device data, training data, customized interventions, training content, and other data, as well as for intervention services, as described herein.

Accordingly, in one implementation, intervention events may be detected and customized interventions may be triggered and presented via the cash management system 102 and controlled remotely by a training administrator (e.g., vendor) using the user device 204 over the network 202. In some cases, the customized intervention may include exams that users take to certify knowledge before user can perform certain (or all) functions on the cash management system 102. Stated differently, the intervention system 104 may ensure users have followed certain aspects of a training curriculum before the user is permitted to perform certain functions. For example, a user may not be able to check out a till until the user has completed training about checking out a till on the cash management system 102. As such, the intervention system 104 may include exam materials, and track the user scores on the exams to determine which users are allowed to access which functions of the cash management system 102.

The training may be web-based with a training level of various users tracked and reported using the intervention system 104. The training may be provided on demand, when user completes certain training activities, on a scheduled basis, and/or the like. The training may be provided to new users, individually or in-groups, and according to user type (e.g., clerks, managers, executives, couriers, service people group members). Additionally, training records and materials may be shared peer-to-peer to facilitate and improve user competency.

As describe herein, the intervention system 104 may trigger training to be displayed on the cash management device using the interactive interface system 106 and additionally or alternatively provide access to outside training material. For example, the intervention system 104 may display or print a QR code or other symbology or provide a hyperlink using the interactive interface system 106 that the user would follow to receive the training material. This material could be displayed on the user device 204 separate from the cash management system 102 itself. The intervention system 104 may generate and send a notification, such as an e-mail, text, or the like with the link/code/files to a user whose contact information is entered into the intervention system 104 for such a purpose. In one implementation, the user of the cash management system 102 is associated with an instance of a training application generated by the intervention system 104 on the user device 204. The intervention system 104 updates the training application to provide training to the user on the user device 204. The intervention system 104 may generate and send notifications to the user, such as by text, e-mail, badges, or banners informing the user that training is available and/or required.

In one implementation, the intervention system 104 records an actual session of a user (the user interface of the cash management system 102, via the interactive interface system 106 and in some cases including video of the user) interacting with the cash management system 102. The intervention system 104 provides access to the recording to the user, the manager, the channel partner, and the vendor for additional training opportunities and for risk management purposes.

All transactions completed using the cash management system 102 are stored in association with a user profile in local memory or in the one or more databases 206. In one implementation, the transaction reports are transmitted to a CIT operator, a financial institution system, and/or the like over the network 202 or via a wired connection by a courier. Based on the transaction reports, funds for the organization are managed through balancing, reconciliation, credit, and/or other accounting purposes. Conventionally, any use of the cash management system 102 is recorded and transmitted in such transaction reports, thereby making hands-on training difficult.

As such, in one implementation, the intervention system 104 commands the cash management system 102 to enter into a training mode, which is offline for accounting purposes but still available for user training. In training mode, the user can practice dispensing a till; depositing a till; advancing cash, depositing cash and vault drops, receiving change orders, requesting additional help, and all other functions the user would be expected to perform on the cash management system 102. The cash management system 102 would provide and receive actual currency while in the training mode, but the transactions within training mode would not be accounted for as site transactions. A transaction is generated for advancing funds to the training activity, and for the funds received and dispensed during the training, which includes any discrepancies between the total dispensed and the total received for the offline training.

Training new users can similarly be challenging on a regular basis. Thus, in one implementation, the intervention system 104 permits a new user to be added to the device without a supervisor or manager needing to be there. For example, the new user may self-enroll using the intervention system 104 and select which manager the user reports to. The intervention system 104 may send a message to the selected manager to confirm the identity and role of the new user. The training administrator may be used for this confirmation as well. The intervention system 104 may provide a unique “challenge code” to be entered by the user to confirm the account and when properly entered would enable the intervention system 104 to set up this user as a novice, with no accomplished training. The intervention system 104 would then assist the user with gaining relevant knowledge before the user is able to accomplish the tasks necessary on the cash management system 102.

Additionally, the intervention system 104 may incorporate video captured from the site. For example, User A was not on-site but was logged into the cash management system 102 because User B logged in as User A. The intervention system 104 detects the discrepancy and triggers an associated intervention event. In response to the intervention event, the intervention system 104 generates a customized intervention in the form of training to stop User B from performing activities that User A should perform. The intervention system 104 may employ facial recognition as a form of authentication using the interactive interface system 106, as described herein. The input system 108 may include a camera integrated into the cash management system 102, remote from the cash management system 102 on-site, and/or the like to perform facial recognition. Moreover, in some cases, the intervention system 104 may utilize the interactive interface system 100 to recognize and automatically authenticate users before the user performs authentication steps for the cash management system 102. Upon automatic authentication, the intervention system 104 and/or the cash management system 102 may automatically display activities the user is expected to perform on the cash management system 102.

Overall, the intervention system 104 provides a training artifact plus an algorithm to automatically coordinate various training activities for the cash management systems 102. The intervention system 104 ensures new users of the equipment of the systems 102 are properly trained. The intervention system 104 also monitors characteristics (heuristics) of the operation of the systems 102 to detect suboptimal, or improper, use of equipment. When the intervention system 104 detects suboptimal, or improper, use of the equipment, it triggers a customized intervention in the form of a training or a retraining session for that user or group of users. One example is if the user is unable to complete a specific task, such as clearing a jam, then the intervention system 104 automatically sources the training for that task to assist the user at the time the assistance is required. Another example is that the intervention system 104 monitors the behavior of the user, for instance, such as the number of times they push the “back” button and generates a customized intervention in the form of a scheduled training for the user to improve the efficiency of the operation of the system 102 by the user. The intervention system 104 includes intervention data about training records for each user, so if a new user, who has not used the system 102 before, attempts to login, the intervention system 104 ensures the user is trained before allowing the user to complete certain tasks on the system 102. Another example is that a configurable setting could be implemented for the intervention system 104 related to elapsed time since certain device functions were completed by this user. For example, if it has been longer than 6 weeks since the user has prepared a deposit on the system 102, the intervention system 104 may provide a customized intervention in the form of a refresher training about preparing a deposit before the system 102 allows this user to perform that function.

As described herein, the intervention system 104 may be used to identify and recommend training sessions by a training administrator, such as a vendor or manufacturer, on-site or via the network 202, as well as provide access to videos, recordings, manuals, tutorials, exams, and/or other training materials or sessions in customized interventions. Additionally or alternatively, the intervention system 104 may utilize artificial intelligence to provide a self-contained training system for providing initial training, detecting intervention events, generating customized interventions, and controlling access to the cash management system 102 based on the training.

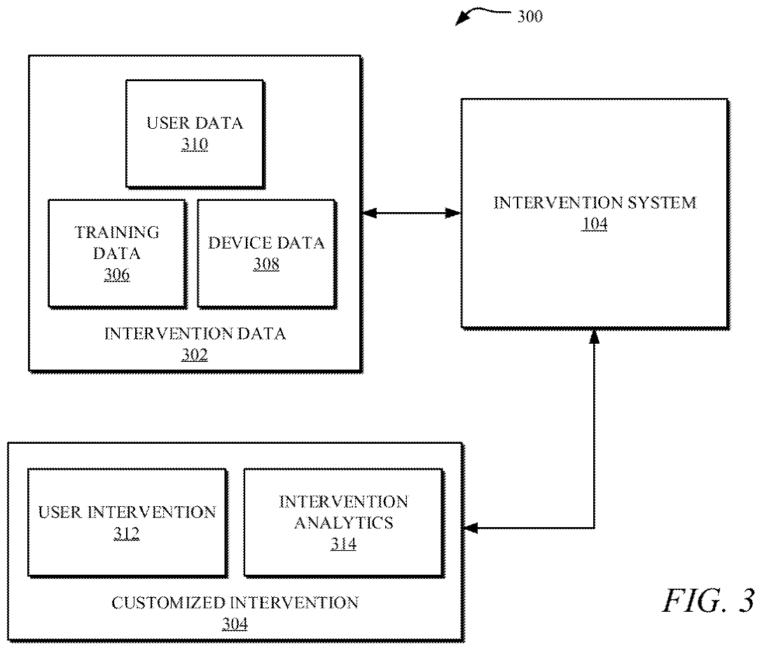

Turning to FIG. 3, in one implementation, intervention data 302 is provided to the intervention system 104 in an environment 300 to generate customized interventions 304 using a trained neural network or other deep learning or artificial intelligence techniques. In one implementation, the one or more databases 206 store training data 306 for regularly training the neural network of the intervention system 104, device data 308 associated with operations executed by the cash management system 102, and a user data 310, including user profiles, and user activities corresponding to operation of the cash management system 102, user training activities, user expectations, and/or the like. Using intervention data 302, the intervention system 104 outputs the customized interventions 304 for an individual user or a group having a plurality of individual users. The customized interventions 304 may include a user intervention 312 corresponding to real-time intervention events or intervention analytics 314 corresponding to historical intervention events.

The neural network of the intervention system 104 is routinely retrained with the training data 306, for example as additional intervention events are triggered, new users are added, or otherwise with updated user or device activity. Generally, the intervention system 104 utilizes deep learning techniques to generate the customized interventions 304 for a particular user, site, group of users, user type, site type, geographical area, and/or the like. In one implementation, the intervention system 104 includes a learned neural network trained with the training data 306 to detect intervention events and generate a training or other intervention that is unique to each detected intervention event, including those corresponding to new users and users experiencing issues. The training data 306 may include a library of baseline intervention events with embeddings to corresponding interventions, with the training data 306 being regularly updated for retraining the neural network of the intervention system 102. For example, the training data 306 may include user inefficiency data corresponding to instances where user navigation is inefficient (e.g., frequent navigation to unnecessary screen, frequent use of a back button, inefficient processing workflows, etc.). Here, the training data 306 may include recorded user sessions with proper navigation and recorded user sessions with inefficient navigation with embeddings to predict whether additional training is needed. The training data 306 may further include error data corresponding to atypical error conditions of the cash management system 102, such as jams, introduction or presence of foreign matter, timeouts, and/or the like. Here, the training data 306 may include transaction records for proper cash management system 102 use and transaction records leading to error conditions with embeddings to predict whether additional training is needed. The customized intervention 304 may include a determination of whether a user or site has a need for additional training and either provide recommendations for the training by the training administrator or automatically conduct the training. The intervention data 302 may use records and logs in real time or achieved data from remote management data.

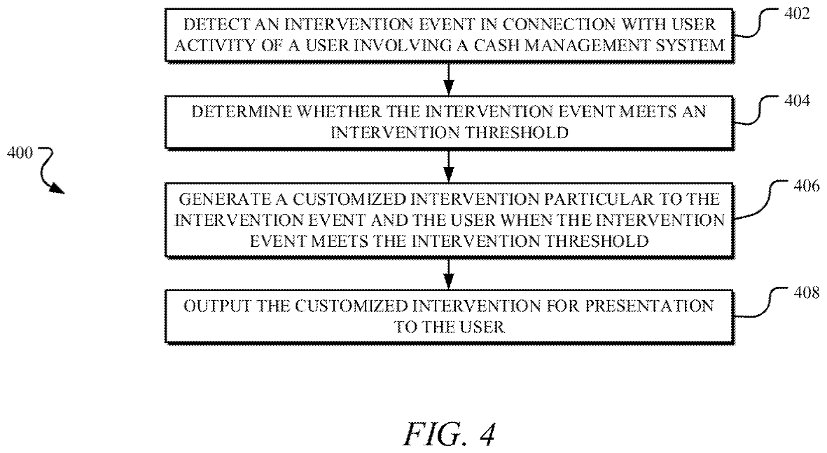

Turning to FIG. 4, example operations 400 for improving cash management system operation. In one implementation, an operation 402 detects an intervention event in connection with user activity of a user involving a cash management system, and an operation 404 determines whether the intervention event meets an intervention threshold. An operation 406 generates a customized intervention particular to the intervention event and the user when the intervention event meets the intervention threshold. An operation 408 outputs the customized intervention for presentation to the user, the customized intervention improving the user activity involving the cash management system.

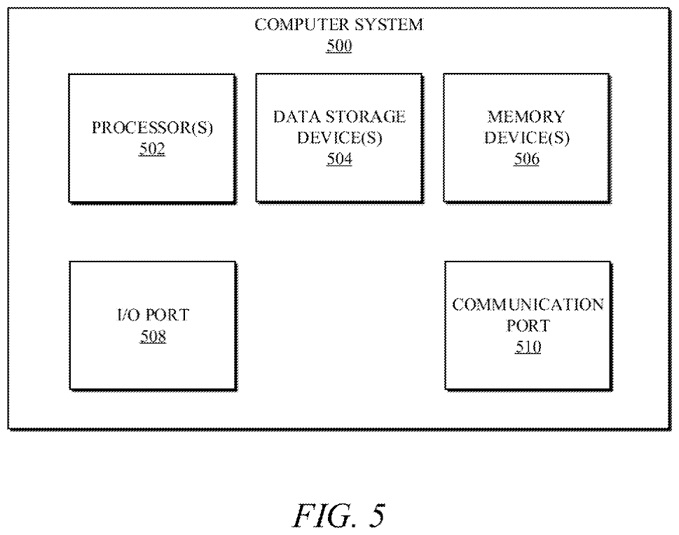

Referring to FIG. 5, a detailed description of an example computing system 500 having one or more computing units that may implement various systems and methods discussed herein is provided. The computing system 500 may be applicable to the cash management system 102, the intervention system 104, the interactive interface system 106, the user devices 202, and other computing or network devices of the environments 100-300. It will be appreciated that specific implementations of these devices may be of differing possible specific computing architectures not all of which are specifically discussed herein but will be understood by those of ordinary skill in the art.

The computer system 500 may be a computing system is capable of executing a computer program product to execute a computer process. Data and program files may be input to the computer system 500, which reads the files and executes the programs therein. Some of the elements of the computer system 500 are shown in FIG. 5, including one or more hardware processors 502, one or more data storage devices 504, one or more memory devices 508, and/or one or more ports 508-510. Additionally, other elements that will be recognized by those skilled in the art may be included in the computing system 500 but are not explicitly depicted in FIG. 5 or discussed further herein. Various elements of the computer system 500 may communicate with one another by way of one or more communication buses, point-to-point communication paths, or other communication means not explicitly depicted in FIG. 5.

The processor 502 may include, for example, a central processing unit (CPU), a graphics processing unit (GPU), a microprocessor, a microcontroller, a digital signal processor (DSP), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computer system 500 may be a conventional computer, a distributed computer, or any other type of computer, such as one or more external computers made available via a cloud computing architecture. The presently described technology is optionally implemented in software stored on the data stored device(s) 504, stored on the memory device(s) 506, and/or communicated via one or more of the ports 508-510, thereby transforming the computer system 500 in FIG. 5 to a special purpose machine for implementing the operations described herein. Examples of the computer system 500 include personal computers, terminals, workstations, mobile phones, tablets, laptops, personal computers, multimedia consoles, gaming consoles, set top boxes, and the like.

The one or more data storage devices 504 may include any non-volatile data storage device capable of storing data generated or employed within the computing system 500, such as computer executable instructions for performing a computer process, which may include instructions of both application programs and an operating system (OS) that manages the various components of the computing system 500. The data storage devices 504 may include, without limitation, magnetic disk drives, optical disk drives, solid state drives (SSDs), flash drives, and the like. The data storage devices 504 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 504 and/or the memory devices 506, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 500 includes one or more ports, such as an input/output (I/O) port 508 and a communication port 510, for communicating with other computing, network, or vehicle devices. It will be appreciated that the ports 508-510 may be combined or separate and that more or fewer ports may be included in the computer system 500.

The I/O port 508 may be connected to an I/O device, or other device, by which information is input to or output from the computing system 500. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 500 via the I/O port 508. Similarly, the output devices may convert electrical signals received from computing system 500 via the I/O port 508 into signals that may be sensed as output by a human, such as sound, light, and/or touch. The input device may be an alphanumeric input device, including alphanumeric and other keys for communicating information and/or command selections to the processor 502 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 500 via the I/O port 508. For example, an electrical signal generated within the computing system 500 may be converted to another type of signal, and/or vice-versa. In one implementation, the environment transducer devices sense characteristics or aspects of an environment local to or remote from the computing device 500, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 500, such as, physical movement of some object (e.g., a mechanical actuator), heating or cooling of a substance, adding a chemical substance, and/or the like.

In one implementation, a communication port 510 is connected to a network by way of which the computer system 500 may receive network data useful in executing the methods and systems set out herein as well as transmitting information and network configuration changes determined thereby. Stated differently, the communication port 510 connects the computer system 500 to one or more communication interface devices configured to transmit and/or receive information between the computing system 500 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 510 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 510 may communicate with an antenna or other link for electromagnetic signal transmission and/or reception.

In an example implementation, operations for user training, intervention data, customized interventions, data, and software and other modules and services may be embodied by instructions stored on the data storage devices 504 and/or the memory devices 506 and executed by the processor 502.

The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for improving cash management system operation, the method comprising:
detecting an intervention event in connection with user activity of a user involving a cash management system;
determining whether the intervention event meets an intervention threshold;
generating a customized intervention particular to the intervention event and the user when the intervention event meets the intervention threshold; and
outputting the customized intervention for presentation to the user, the customized intervention improving the user activity involving the cash management system.

2. The method of claim 1, wherein detecting the intervention event includes detecting one or more of an erroneous action by the user, an inefficient action by the user, and a new action for the user.

3. The method of claim 2, wherein the intervention event is the new action for the user and the user activity is one or more of:
operating the cash management system;
auditing the cash management system;
performing maintenance on the cash management system; and
configuring the cash management system.

4. The method of claim 1, wherein the user activity corresponds to addressing an operational error of the cash management system, and outputting the customized intervention includes presenting, while the user activity is ongoing, a demonstration of a process for resolving the operational error.

5. The method of claim 4, wherein the operational error is a note jam, a coin jam, or a presence of a foreign item, and the demonstration is a video presentation of how to clear the note jam, the coin jam, or the foreign item.

6. The method of claim 1, wherein the intervention threshold is a threshold number of previous occurrences of the user activity being performed, and determining whether the intervention event meets the intervention threshold includes determining whether the user has previously performed the user activity a number of times less than the threshold number.

7. The method of claim 1, wherein the intervention threshold indicates an amount of time, and determining whether the intervention event meets the intervention threshold includes determining whether the amount of time has elapsed since the user previously performed the user activity.

8. The method of claim 1, wherein detecting the intervention event includes detecting a number of times a back button is triggered, and outputting the customized intervention includes scheduling a training session for the user.

9. The method of claim 1, further comprising:
detecting, for a particular group of users, a level of training and an amount of user experience; and
generating a competency baseline based at least partly on the level of training and the amount of user experience, the customized intervention corresponding to the competency baseline.

10. The method of claim 1, wherein the user activity includes one or more of depositing funds, dispensing funds, making change, providing card-related services, checking in tills, rolling coins, authenticating a user, dropping packages into a drop vault, cashing checks, and clearing a jam.

11. The method of claim 1, wherein the customized intervention includes providing a link or a QR code for accessing training content at a device remote from the cash management system.

12. The method of claim 1, further comprising generating a report indicating intervention analytics associated with the user activity, the intervention analytics including data:
aggregated according to one or more of an individual user, a user type, a site, a site type, a geographical area, a device type, and an organization; and
indicating one or more of a number of login attempts, a number of unexpected button pushes, a number of attempts at manually evoking help, and a number of note jams or coin jams.

13. The method of claim 1, the method comprising:
detecting the user within a threshold distance of the cash management system;
determining an identity of the user using an authentication system;
determining an authentication level for the user based on the identity of the user;
bypassing a login operation for the cash management system based on the identity and the authentication level for the user; and
customizing one or more settings of the cash management system based on the identity and the authentication level for the user.

14. The method of claim 13, further comprising receiving, using one or more biometric sensors, biometric data associated with the user, wherein determining the identity of the user is based at least partly on the biometric data.

15. A method for improving cash management system operation, the method comprising:
causing a cash management system to be in a transactional mode;
detecting an intervention event in connection with user activity of a user involving the cash management system in the transactional mode;
generating a customized intervention particular to the intervention event and the user;
outputting the customized intervention for presentation to the user, the customized intervention improving the user activity involving the cash management system;
receiving a command at the cash management system to initiate a training mode; and
transitioning the cash management system from the transactional mode to the training mode, the training mode including a training activity using training funds in connection with operation of the cash management system.

16. The method of claim 15, further comprising:
dispensing a first set of funds having a value corresponding to the training funds from the cash management system, the first set of funds being dispensed as an initial cash management operation;
executing a set of one or more cash management operations using the first set of funds with the cash management system;
receiving a second set of funds at the cash management system as a final cash management operation corresponding to a conclusion of the training activity;
designating the initial cash management operation, the set of one or more cash management operations, and the final cash management operation as training operations, the training operations being distinguished from transaction operations for the cash management system; and
transitioning the cash management system from the training mode to the transactional mode.

17. The method of claim 16, further comprising confirming that the second set of funds has a value corresponding to the training funds.

18. The method of claim 16, wherein the training operations are excluded from a report detailing the transaction operations for the cash management system.

19. The method of claim 16, wherein the command includes an indication of a user type and the training activity corresponds to the user type, the user type being clerks, managers, executive, couriers, or service people.

20. A method for improving cash management system operation, the method comprising:
causing a cash management system to be in a transactional mode;
detecting a user within a threshold distance of the cash management system;
determining an identity of the user using an authentication system;
determining an authentication level for the user based on the identity of the user;
customizing one or more settings of the cash management system based on the identity and the authentication level for the user;
detecting an intervention event in connection with user activity of the user involving the cash management system in the transactional mode;
generating a customized intervention particular to the intervention event and the one or more settings;
outputting the customized intervention for presentation to the user, the customized intervention improving the user activity involving the cash management system; and
transitioning the cash management system from the transactional mode to a training mode, the training mode including a training activity using training funds in connection with operation of the cash management system.
